(19) United States
(12) Patent Application Publication
(10) Pub. No.: US 2002/0131600 A1
(43) Pub. Date: Sep. 19, 2002

(54) Authentication and data security system for communications

(76) Inventor: Marius Constantin Ionescu, Vancouver (CA)

Correspondence Address: Paul D. Gornall, Barrister & Solicitor, Reg'd Patent & TM Agent, 1820 - 355 Burrard St., Vancouver, V6C 2G8, CA

(21) Appl. No.: 09/814,680

(22) Filed: Mar. 19, 2001

(51) Int. Cl. H04L 9/00

(52) U.S. Cl. 380/277; 705/71

(57) ABSTRACT

This invention is a dynamic parameterized context dependent cryptosystem, for general security and privacy of a communication vis-a-vis outsiders, while also limiting the access of a third party involved in the communication to selected portions of the communicated information, on a need-to-know basis. The invention thus provides an authentication and data security system for communications between two or more parties. The system provides a communication key that is derived by a first party subsystem using an encryption algorithm from key data previously provided by a second party subsystem to the first party subsystem. The communication key is transmitted to the second party subsystem, which uses a decryption algorithm to check whether the communication key was derived from any of various key data from a previously provided data pool related to the first party. The “communication key” is a mathematically derived form of a data context. It is self-encrypted in that no external keys, whether secret or public, are involved in the process.

### BACKGROUND OF THE INVENTION

The present invention relates to cryptology and, in particular, to systems involving communications between two or more parties, where security and privacy of some or all of the communication is desired.

The pervasive development of global digital communications, particularly internet or Web-based commerce, has increased the need to address two problems in open computer networks and communications systems, whether wired or wireless: protecting sensitive data, and ensuring the privacy of the participants in the transactions and communications.

In providing a unified solution for both problems, a current approach is to use a Public Key infrastructure with digital certificates, in which individuals are each given an identity certificate that will form the basis of all their communications and transactions. This approach had the inefficiency and potential detriment of involving at least one auxiliary “trusted” third party.

Encryption of stored and transmitted data is insufficient to meet the privacy concerns. Confidentiality protects data only against outsider attacks and does not prevent the parties to a transaction or communication, or anyone having authorized access to the stored or transmitted data, from selling, linking, tracing or using the data in whatever manner they choose.

To address the privacy problem, current systems use information intermediaries, also known as infomediaries, who claim some of the goals of privacy. Infomediaries require their customers to surrender identifiable personal data and to funnel their communications and transactions through the infomediary company.

Individuals do not have control over their own information if they subscribe to infomediaries. The infomediaries and their computer network servers are an appealing target for hackers and malicious insiders.

### SUMMARY OF THE INVENTION

This invention provides a dynamic parameterized context dependent cryptosystem, which can be used for data encryption and authentication, providing general security and privacy of a communication vis-a-vis outsiders, while also limiting the access of a third party involved in the communication to selected portions of the communicated information, on a need-to-know basis.

The invention thus provides an authentication and data security system for communications between two or more parties, in which:

a) a communication key is derived by a first party subsystem using an encryption algorithm from key data previously provided by a second party subsystem to the first party subsystem;

b) the communication key is transmitted to the second party subsystem, which uses a decryption algorithm to check whether the communication key was derived from any of various key data from a previously provided data pool related to the first party.

The “communication key” is a mathematically derived form of a data context. It is self-encrypted in that no external keys, whether secret or public, are involved in the process. In mathematical terms, the communication key can be stated as the solution of the equation

context*x≡1modulo n,

where n=f(context) and (context,n)=1, i.e context and n are coprime.

The transmission may be made indirectly through a third party subsystem involved in the transaction, the third party using the communication key as an authentication key for a specific transaction involving the three parties. Thus the third party would know that the communication key has been transmitted, and could use or retain the communication key in the third party's records of the transaction, without actually knowing the key data that resulted in the communication key.

In a preferred implementation of the authentication and data security system:

a) a bank (the second party) processes a request to approve the transaction from a merchant (the third party) if the communication key was derived from any of various key data from a previously provided data pool related to first party, such as credit card data consisting of several credit cards numbers and respective expiry dates relating to the first party, a consumer;

b) the bank confirms its approval of the transaction by seeking an approval from the bank's customer, a consumer (the first party);

c) the bank transmits the results of the request to approve to the merchant;

d) the bank and the customer are privy to the key data, but it is not revealed to the merchant;

e) the communication key but not the credit card data is transmitted by the customer over the internet (or other communication channel, including wireless and satellite) to the merchant, who in turn transmits it to the bank with a request to authorize the transaction.

Such a system can be implemented with an encryption algorithm that is dynamic in that it is context dependent, namely:

selecting secret key p, derived from the parameterized context contextParam, being a prime number greater then 2, where contextparam=f(context,parameter), context∈Z, parameter∈P, P⊂Z, and p=g(contextParam);

selecting secret key n, derived from the parameterized context, being a positive integer greater then 0, where n=h(context,parameter);

selecting modulus m, being a positive integer and

m=pⁿ (1)

selecting an encryption key α, derived from the parameterized context, where a k(context,parameter), which is a member of the finite group Mₘ of residue classes prime to m under multiplication modulo m, and being prime to θ(m), where

θ(m)=pⁿ(1−1/p); (2)

selecting a communication key α1, which is a member of the finite group Mₘ of residue classes prime to m under multiplication modulo m, and being prime to θ(m), where α1 can be determined using

α*α1≡1modθ(m), (3)

and processing communication data as a member of Zₘ by performing the operations on the said communication data, whereby the said operations can be determined on the basis of (3).

A preferred embodiment of the present invention is described by way of example only, and involves the transformation:

x∈Zₘ→α1→x∈Zₘ. (4)

The State Machine of the said transformation is provided, including:

transition diagram of an element x∈Zₘ from the initial state to the encrypted state, defined as:

x∈X_{encrypted}

x→α=k(x,parameter)→α1, where α*α1≡1modθ(mₓ), and (5)

X_{encrypted}=α1; (6)

transition diagram of an element from the encrypted state to the decrypted state x∈Zₘ, defined as:

X_{encrypted}→x

for ∀z∈L, where L is the list of possible candidates for x, L⊂Z,

z→α=k(z,parameter) (7)

if α*X_{encrypted}=1modθ(m_{z}) then z=x=X_{decrypted} and stop (8)

The system is also applicable to situations where it is intended that a third party tapping into a communication between the first and second parties receive no useful information at all, such as a communication between a cellular phone and its carrier company to request a phone call be made based on the cellular phone's identification code. With the present invention, an interception of the encrypted code and parameter will do nothing for an interloper hoping to clone the phone identification code in another device.

### BRIEF DESCRIPTION OF THE DRAWINGS

FIG. 1 illustrates a current approach to data security and authentication involving three parties communicating over a computer network, compared to the system of the present invention.

FIG. 2 shows a comparison of information flow in unencrypted data transmission, a current approach to data security and authentication involving third party certifying authorities, and the encryption method of the present invention.

FIG. 3 shows the system of the present invention, used for data security and authentication involving three parties communicating in regard to a transaction over a computer network

FIG. 4 is a flow chart showing a dynamic encryption method used to implement the system of the present invention.

FIG. 5 is a flow chart showing an example of the encryption module of the current invention.

FIG. 6 is a flow chart showing an example of the decryption module of the current invention.

FIG. 7 is a flow chart showing an example of an alternate decryption module of the current invention.

FIG. 8 is a flow chart showing the use of an increment to enable dynamic security of authentication of the first and second parties.

FIG. 9 shows the system of the present invention, used for data security and authentication involving two parties communicating over a cellular phone network.

### DETAILED DESCRIPTION

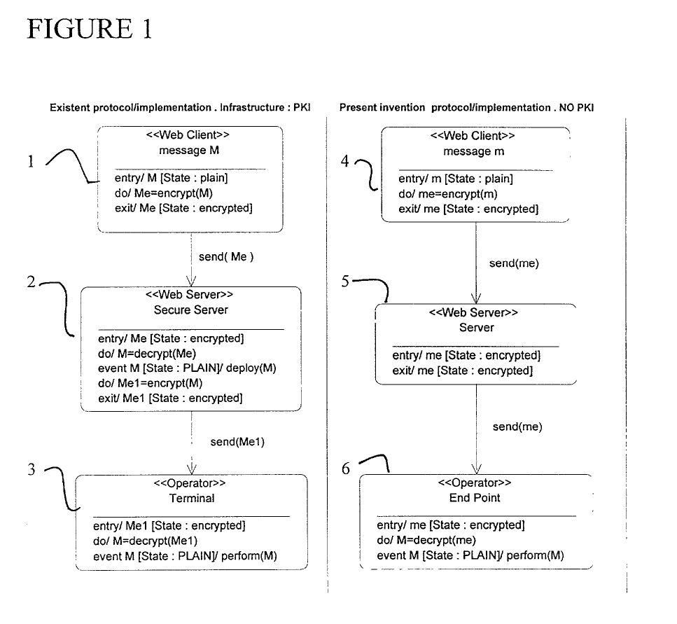

Referring to FIG. 1, the protocol and implementation of a “secure server” encryption system down the left flow chart 1 to 3 is compared to that of the present invention down the right flow chart 4 to 6, showing the extra steps of decrypt, deploy, encrypt, in block 2 of the left flow chart for the “secure server” method.

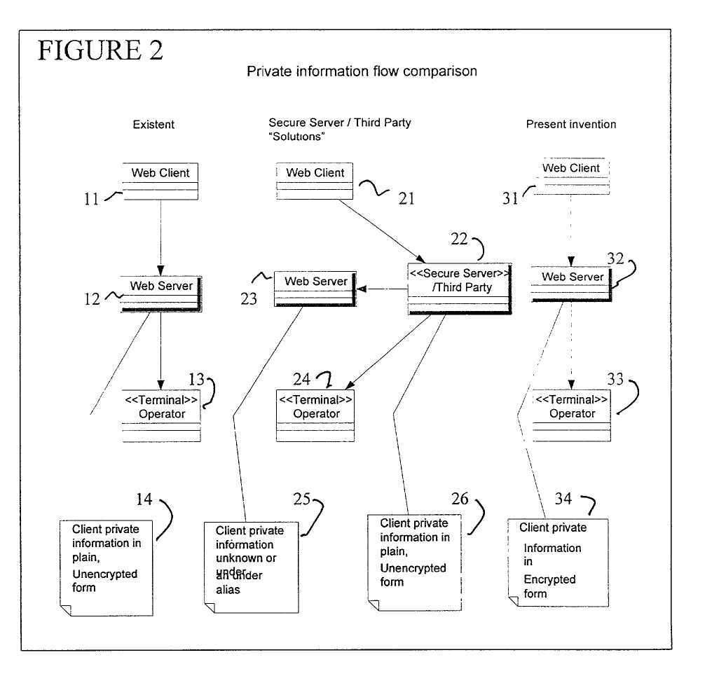

Referring to FIG. 2, a comparison of three methods of private information flow is shown. In the left vertical flow chart 11 to 14, the exposure of unencrypted private information is plain, and can be hacked from the web server by electronic intrusion or simply taken by the terminal operator. In the middle vertical flow chart 21 to 26, encryption is used, but with extra steps and risk involving the “secure server” 22 and its terminal operator 24 system. In the present invention, the rightmost vertical flow chart 31 to 34 shows the reduced steps but the data is encrypted.

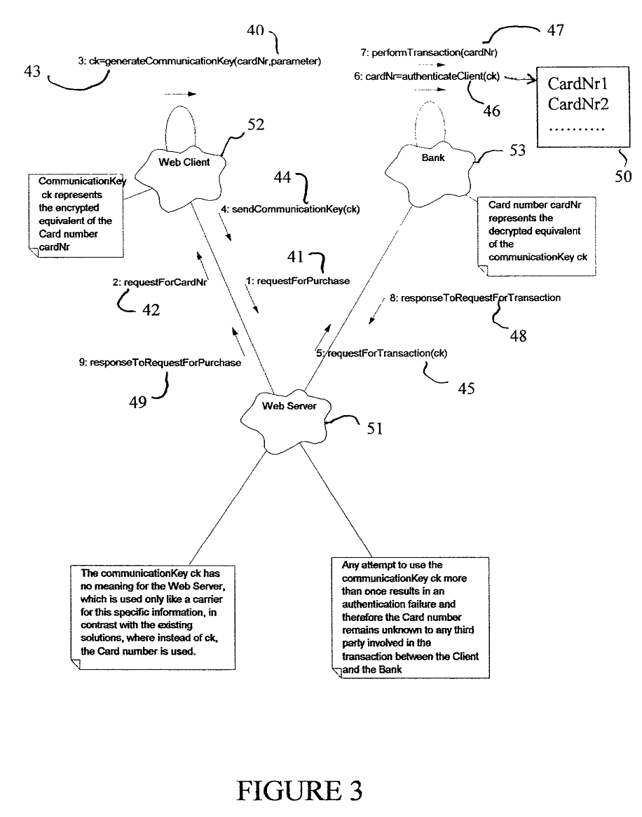

Referring to FIG. 3, the involvement of a merchant third party subsystem at Web Server 51 who is not privy to the actual credit card key data 50 supplied by the a bank 53 second party subsystem or to the actual credit card and parameter 40 selected by the customer first party subsystem at Web Client 52 and encrypted in response to a request from the merchant third party subsystem at Web Server 51. The merchant third party subsystem at Web Server 51 only receives the communication key, that is, the encrypted credit card number together with instances of such other parameters as have been prearranged for the system, in response to request of the merchant third party subsystem for credit card information, as indicated in the consecutive first four steps 41 to 44. The merchant third party subsystem at Web server 51 passes this communication key on to the bank second party subsystem 53 along with the merchant's request for authorization to debit the credit card account (the fifth step 45). The bank second party subsystem 53 decrypts with various potential keys from a pool of key data 50 relating to the customer until a match if found and authorization is deemed to be appropriate (the sixth and seventh steps 46 and 47). Optionally, the bank second party subsystem could in turn seek a verification from the customer first party subsystem using the same kind of dynamic communication key data pool system before responding to the merchant third party subsystem (the eighth step 48), which could then complete the transaction (step nine 49).

The purpose of the parameter being included for encryption into the communication key is to render the communication key a one-time use only key that is useless after the initial transaction for which it was created. The authorization system of the bank second party subsystem would be programmed to reject any second attempt to authorize a debit using a communication key from a customer first party subsystem that had already been used. It could reject based on date and time parameters that are no longer valid, or any other standard for comparison, including simple incrementing of a counter, or by maintaining a list of all communication keys that had already been used within an applicable time period. An outsider would not be able to alter the parameters to a current one in order to falsely obtain an authorization or to pretend to be the customer as the parameters and the original credit card data are all mixed within the encrypted communication key.

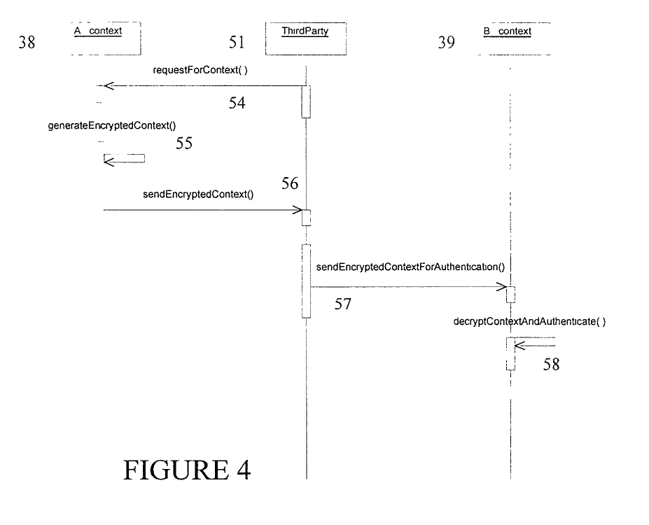

Referring to FIG. 4, the Third party subsystem 51 requests 54 information relating to the A:context 38 (a context of the first party subsystem), which is then encrypted 55 and sent in encrypted form 56 to the Third party subsystem 51. The Third party subsystem 51 passes it with a request to authorize 57 to the B:context 39 (a context of the first party subsystem), where it is decrypted and authenticated 58.

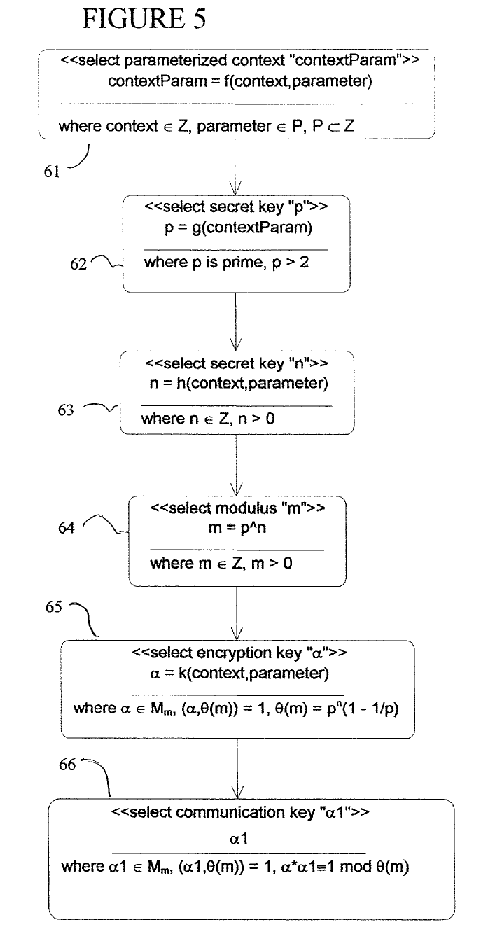

Referring to FIG. 5, a preferred embodiment of the encryption method of the present invention is shown in encryption flow chart 61 to 66. For example, applying the transformation shown in the flow chart to a simple 4-digit number (instead of a 16-digit credit card number for ease of illustration):

if

context=x=1234,

parameter=2,

contextParam=f(context,parameter)=context+parameter, then contextParam=f(1234,2)=1236,

p=g(contextParam)=nextPrime(contextParam), then p=g(1236)=1237,

n=h(context,parameter)=length(context)−parameter+1, then n=h(1234,2)=3,

then the modulus m=pⁿ, is

m=1237³=1892819053, and

θ(1892819053)=1237³(1-1/1237)=1891288884.

Selecting the encryption key α,

α=k(context,parameter)=context+1 , then α=k(1234,2)=1235,

where (1235, 1891288884)=1,

then the communication key is α1=1418083811,

where 1235*1418083811≡1modθ(1892819053);

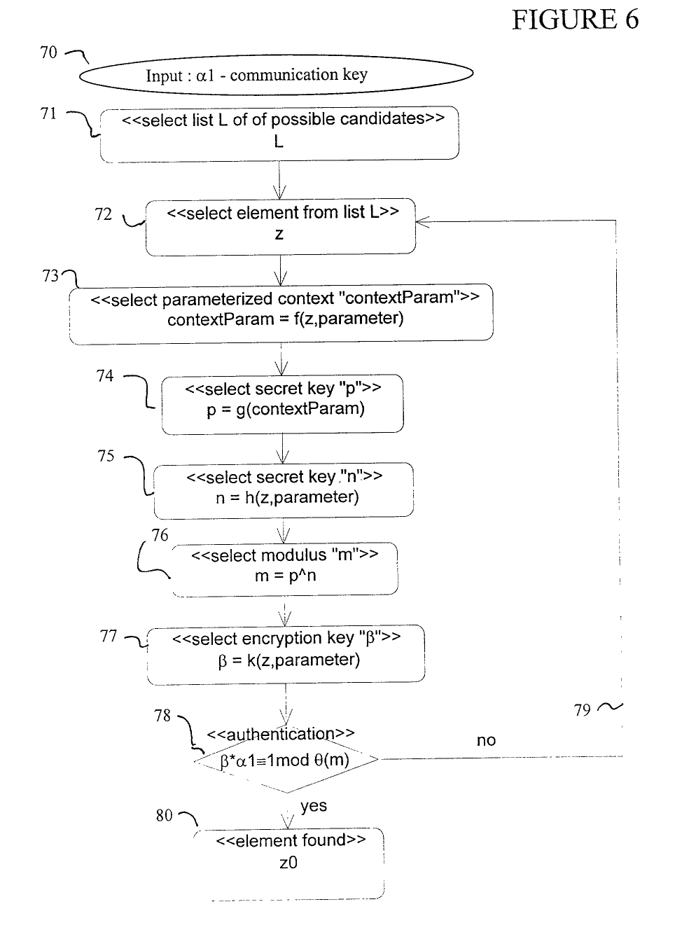

Referring to FIG. 6, the corresponding decryption flow chart 70 to 80 is shown, and applying it to the foregoing example:

if the list L of possible candidates for x is L{1122,1234}, performing the same operations for the elements of L,

context=z=1122,

parameter=2,

contextParam=f(context,parameter)=context+

parameter, then contextParam=f(1122,2)=1124,

p=g(contextParam)=nextPrime(contextParam), then p=g(1124)=1129,

n=h(context,parameter)=length(context)−parameter+1, then n=h(1234,2)=3,

then the modulus m=pⁿ, is

m=1129³=1439069689, and

θ(1439069689)=1129³(1−1/1129)=1437795048

Selecting the encryption key α,

α=k(context,parameter)=context+1 , then α=k(1122,2)=1123, and

performing authentication≡1123*1418083811modθ(1439069689), where authentication=869001617, and because authentication≠1 select next in list L,

context=z=1234,

parameter=2,

contextParam=f(context,parameter)=context+parameter, then contextParam=f(1234,2)=1236,

p=g(contextParam)=nextPrime(contextParam), then p=g(1236) =1237,

n=h(context,parameter)=length(context)−parameter+1, then n=h(1234,2)=3,

then the modulus m=pⁿ, is

m=1237³=1892819053, and

θ(1892819053)=1237³(1−1/1237)=1891288884.

Selecting the encryption key α,

α=k(context,parameter)=context+1 , then α=k(1234,2)=1235, and

performing authentication≡1235*1418083811modθ(1892819053), where authentication=1, and because authentication=1, then z=1234 is the decrypted element and stop performing the list L.

In real applications, the data numbers would be larger and the resulting encryption and decryption would involve large calculations, requiring computers to implement effectively, and requiring enormously prohibitive computer-years to decipher without the key data pool.

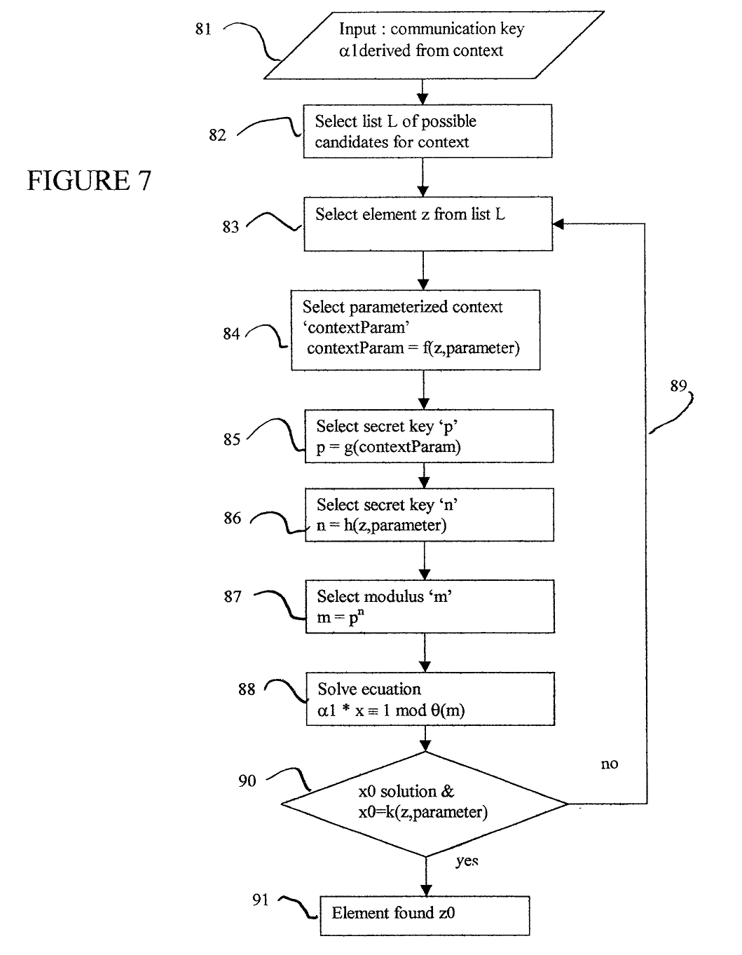

Referring to FIG. 7, in a second variant for the decryption process, the second decryption flow chart 81 to 91 is shown. The State Machine of the said transformation is provided, including:

transition diagram of an element x∈Zₘ from the initial state to the encrypted state, defined as:

x→X_{encrypted}

x→α=k(x,parameter)→α1, where α*α1≡1modθ(mₓ), and

X_{encrypted}=α1;

transition diagram of an element from the encrypted state to the decrypted state x∈Zₘ, defined as:

X_{encrypted}→x

for ∀z∈L, where L is the list of possible candidates for x, L⊂Z,

solve equation

α1=*x≡1modθ(m_{z}), (*)

if the equation (*) has a solution x0 and

x0=k(z,parameter) then z=x=X_{decrypted} and stop.

As an example, if

context=x=1234,

parameter=2,

contextParam=f(context,parameter)=context+parameter, then contextParam=

f(1234,2)=1236,

p=g(contextParam)=nextPrime(contextParam), then p=g(1236)=1237,

n=h(context,parameter)=length(context)−parameter+1, then n=h(1234,2)=3,

then the modulus m=pⁿ, is

m=12373=1892819053, and

θ(1892819053)=12373(1-1/1237)=1891288884.

Selecting the encryption key α,

=k(context,parameter)=concatenation(context,parameter),

where parameter =1 and has a predetermined fixed length, let's say 1, then α=k(1234,1)=12341,

where (12341, 1891288884)=1,

then the communication key is α1=558298793,

where 12341*558298793=1modθ(1892819053);

Now if the list L of possible candidates for x is L{1122,1234}, performing the same operations for the elements of L,

context=z=1122,

parameter=2,

contextParam=f(context,parameter)=context+parameter, then contextParam=f(1122,2)=1124,

p=g(contextParam)=nextPrime(contextParam), then p=g(1124)=1129,

n=h(context,parameter)=length(context)−parameter+1, then n=h(1234,2)=3,

then the modulus m=pⁿ, is

m=1129³=1439069689, and

θ(1439069689)=1129³(1-1/1129)=1437795048

Solving the equation

558298793*x≡1mod1437795048,

because (558298793, 1437795048)=1, then exists a solution

x0 =616515233

Performing authentication xO=concatenation(6165,15233), because

6165≠1122 and length(15233)≠1 then select next in list L,

context=z=1234,

parameter=2,

contextParam=f(context,parameter)=context+parameter, then contextParam=f(1234,2)=1236,

p=g(contextParam)=nextPrime(contextParam), then p=g(1236)=1237,

n=h(context,parameter)=length(context)−parameter+1, then n=h(1234,2)=3,

then the modulus m=pⁿ, is

m=1237³=1892819053, and

θ(1892819053)=1237³(1-1/1237)=1891288884.

Solving the equation

558298793*x≡1mod1891288884,

because (558298793, 1891288884)=1, then exists a solution x0=12341

Performing authentication x0=concatenation(1234,1), because 1234=1234 and length(1)=1 then z=1234 is the decrypted element and stop performing the list L.

There is a significant difference between the two methods of decryption shown in FIGS. 6 and 7. The first method (FIG. 6) uses elements for encryption and decryption previously known by both parties. The second method (FIG. 7) uses also a parameter which is known only by the first party subsystem, for instance a timestamp to the nearest millisecond, which could be concatenated with the context, and the second party subsystem perform the authentication by solving the equation (8), and by verifying the context, the length of the parameter and the sequence of the parameter in a data base.

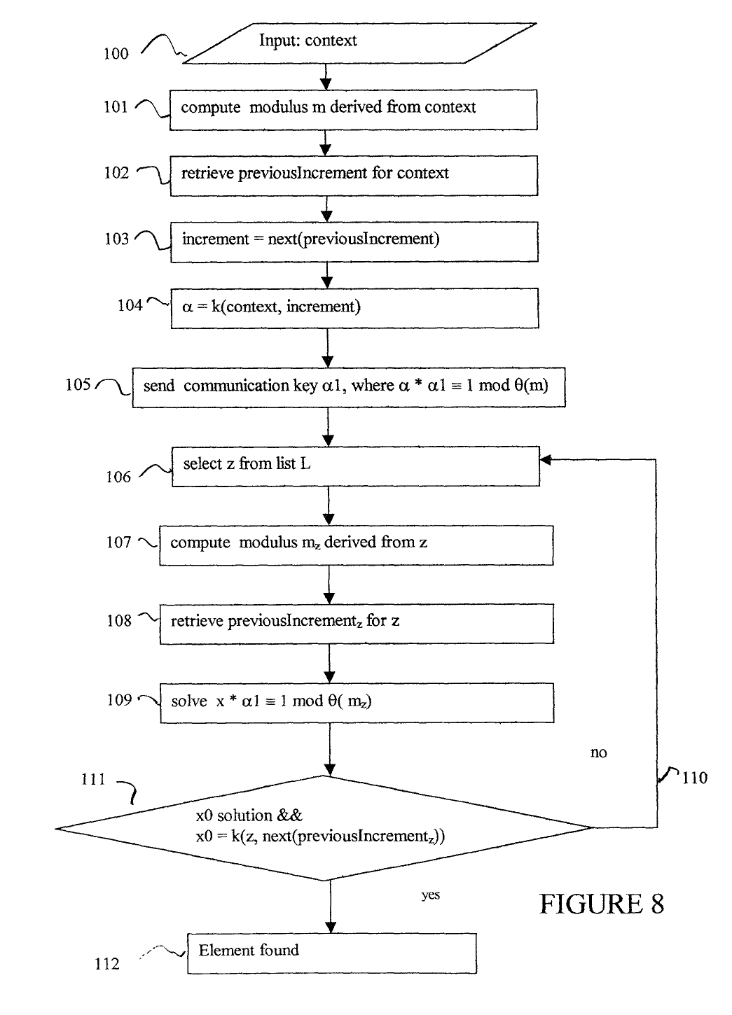

Referring to FIG. 8, an authentication flow chart 100-112 is shown, using an increment parameter that can be used instead of or in combination with the timestamp or other parameters. An increment could be used to provide ongoing security of authentication as indicated. The increment would cause the communication key to be different for each successive bonafide communication between the first and second party subsystems, with each tracking the increment. Thus an interception of the communication key would do an unauthorized third party no good for subsequent illicit use by the third party, because each communication key would be a one-time only bonfide event between the first and second parties. And the third party could not know the increment value at any given time from having intercepted the encoded communication key, because it would just be part of the encrypted content and would be unintelligible to the third party.

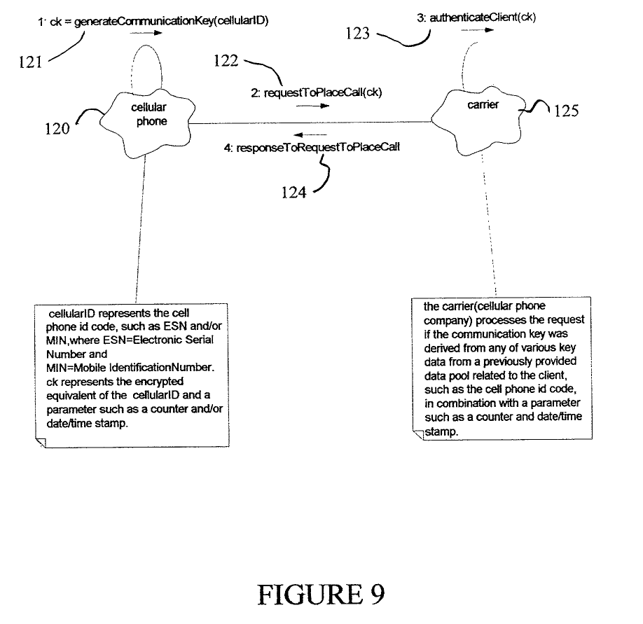

The system is applicable to situations where it is intended that a third party tapping into a communication between the first and second parties receive no useful information at all, as opposed to the merchant example, where it is intended that the merchant make use of the communication key as indecipherable meta-information that fits in with the merchant's authorization for a specific transaction. For example, referring to FIG. 9

a) a cellular phone (the first party subsystem) 120 contacts the user's cellular phone carrier company (the second party subsystem) 125 with an request 122 to place a call;

b) the cellular phone carrier company 125 responds 124 positively to the request if the communication key 121 generated by the cellular phone 120 is found by a decryption and authentication subprocess 123 to be derived from any of various key data from a previously provided data pool related to the first party subsystem, such as the cell phone ID code, in combination with a parameter such as a counter and date/time stamp;

c) interception by a third party illicit cell phone user of the communication key does the third party no good, because the communication key is a one-time use key that cannot be manipulated by the third party to come up with another valid communication key as the key data and the changing parameter are mixed up in the un-decrypted communication key and are unintelligible to the third party illicit cell phone user.

The dynamic parameterized context dependent cryptosystem presented above has a number of significant advantages over previous cryptosystems. The system implements a method in computer networks and other communications devices in which the system has the following advantages:

(i) it eliminates any other third party implied in the authentication of the sender and prevent any access to the content of the context of a third party implied in the transaction, ensuring in that way the privacy of the sender.

(ii) it is flexible, i.e. the modulus m and the communication key a can be relatively easy to generate and can be tailored to obtain all levels of encryption.

(iii) it is dynamic, i.e. the modulus m and the communication α are generated per session of communication and they are unique by implementing the parameter procedure; any other use of the communication key α in another transaction will fail.

(iv) it offers a high level of security of the data communication, residing in the fact that here is no prior information, published or unpublished, about the modulus and the keys used in a transaction, every transaction having its unique set of encryption information.

(v) it is specific, i.e. for every end-to-end point communication the encryption information is tunnelled and shielded for the said communication, and any third party involved in the transaction can only use the communication key for limited purposes such as generation of an authorization number, without any possibility to access the content or information in original data or context.

(vi) it is immune to various man-in-the-middle or homomorphic attacks due to the way the encryption information is attached to the communication.

In a high security system, the variables selected would be appropriately large numbers, resulting in a prohibitively high computing time to crack the encryption by a brute force factoring method without the key data, even if the method of encryption were to become known to a would-be cracker. Moreover, the context parameters chosen could be ones that not only change rapidly, such as the accurate time and date, or a combination of stock quotes, but also could be ones that become unknown as soon as they are used. For example data that is not commonly monitored such as temperatures at a number of secret locations or even a random stream of numbers culled over a brief period that is known only to the parties to the communication could be used as context parameters.

The cryptosystem hereby provided could be embodied in software, hardware or firmware, for use in data storage and communications systems. The first and second party's subsystem could be first and second discrete devices, or a mixture of party's, subsystems, methods and devices. The encryption steps in a programmable computer could be an encryption module hard-wired in a chip or chips in a communication device, and likewise for the decryption or other steps in the system.

The system could be applied to encrypt larger bodies of content than has been indicated above, and could also be used to encrypt private keys for use in ordinary symmetric encryption processes.

The system is extendable to a greater number of parties than illustrated above. For example, a third party receiving a transmitted communication key might seek in regard to an order from the first party who encrypted the communication key, confirmation, or approval from several levels of involved parties privy to the key data, and might pass on the limited information relating to the un-decrypted communication key itself to other non-privy parties as might be required for any administrative or operational system. The system could be nested with levels of communication keys within other communication keys to meet the needs of an organizational hierarchy.

The within-described invention may be embodied in other specific forms and with additional options and accessories without departing from the spirit or essential characteristics thereof. The presently disclosed embodiment is therefore to be considered in all respects as illustrative and not restrictive, the scope of the invention being indicated by the appended claims rather than by the foregoing description, and all changes which come within the meaning and range of equivalence of the claims are therefore intended to be embraced therein.

I claim:

1. An authentication and data security system for communications in which
a) a communication key is derived by a first party subsystem using an encryption algorithm from key data previously provided by a second party subsystem to the first party subsystem;
b) the communication key is transmitted to the second party subsystem, which uses a decryption algorithm to check whether the communication key was derived from any of various key data from a previously provided data pool related to the first party subsystem;

2. The authentication and data security system of claim 1, in which the communication key is transmitted to a third party subsystem, which uses the communication key without decryption as an authentication key in communications with the first and second parties regarding for a specific transaction involving the three parties.

3. The authentication and data security system of claim 2, in which the second party subsystem processes a request to approve the transaction from the third party subsystem if the communication key was derived from any of various key data from the previously provided data pool related to the first party subsystem;

4. The authentication and data security system of claim 3, in which the second party subsystem transmits the results of the request to approve, to the third party subsystem.

5. The authentication and data security system of claim 4, in which the second party subsystem confirms its approval of the transaction by seeking an approval from the first party subsystem, prior to transmitting the second party subsystem's approval to the third party subsystem.

6. The authentication and data security system of claim 2, in which the first and second parties are privy to the key data, but it is not revealed to the third party subsystem.

7. The authentication and data security system of claim 2, in which the first party subsystem is within a consumer's system, the second party subsystem is within a financial institution's system, the third party subsystem is within a merchant's system, and the key data is credit card data.

8. The authentication and data security system of claim 2, in which the communication key but not the credit card data is transmitted by the first party subsystem over the internet to the second party subsystem, who in turn transmits it with a request to authorize the transaction to the third party subsystem.

9. The authentication and data security system of claim 1, in which the encryption algorithm is dynamic.

10. The authentication and data security system of claim 9, in which the encryption algorithm is a context dependent dynamic cryptosystem.

11. The authentication and data security system of claim 10, in which the encryption algorithm includes the operations of:
a) selecting secret key p, derived from the context, being a prime number greater then 2;
b) selecting secret key n, derived-from the context, being a positive integer greater then 0;
c) selecting modulus m, being a positive integer, m=pⁿ;
d) selecting an encryption key α, derived from the context, which is a member of the finite group Mₘ of residue classes prime to m under multiplication modulo m, and being prime to θ(m), where θ(m) =p(1−1/p);
e) selecting a communication key α1, which is a member of the finite group Mₘ of residue classes prime to m under multiplication modulo m, and being prime to θ(m), where α1 can be determined using α*α1≡1modθ(m).

12. The authentication and data security system of claim 11, in which the decryption algorithm includes processing the communication key as a member of Zₘ whereby the operations can be determined using α*α1≡1modθ(m).

13. The authentication and data security system of claim 11, in which the encryption algorithm includes credit card information as the context.

14. The authentication and data security system of claim 11, in which the encryption algorithm includes a unique context parameter that varies the communication key for each communication session, the key data being thereby indeterminable by an outside party subsystem who might monitor a series of such communication keys.

15. The authentication and data security system of claim 11, in which the encryption algorithm includes a parameter from a context that is continually changing, by which the communication key varies for each communication session, the key data being thereby indeterminable by an outside party subsystem who might monitor a series of such communication keys.

16. The authentication and data security system of claim 15, in which the parameter is selected at a time known only to the parties intended to decrypt the communication key.

17. The authentication and data security system of claim 1, in which the communication key for a specific communication session is derived from the key data in combination with a parameter based on an incremented number related to the current communication session in a series of communications between the first and second parties.

18. The authentication and data security system of claim 17, in which the parameter is the number of the current communication session in a series of communications between the first and second parties, and the number is stored as incremental data by each of the first and second parties to enable successive authentication and communication sessions.

19. The authentication and data security system of claim 17, in which the parameter is a date and time relating to the current communication session,

20. The authentication and data security system of claim 4, in which
a) the second party subsystem transmits the results of the request to approve, to the third party subsystem;
b) the second party subsystem confirms its approval of the transaction by seeking an approval from the first party subsystem, prior to transmitting the second party subsystem's approval to the third party subsystem;
c) the first and second parties are privy to the key data, but it is not revealed to the third party subsystem;
d) the first party subsystem is within a consumer's system, the second party subsystem is within a financial institution's system, the third party subsystem is within a merchant's system, and the key data is credit card data;
e) the communication key but not the credit card data is transmitted by the first party subsystem over internet to the second party subsystem, which in turn transmits it with a request to authorize the transaction to the third party subsystem;
f) the encryption algorithm system is asymmetric and dynamic;
g) the encryption algorithm is a context dependent dynamic cryptosystem;

21. The authentication and data security system of claim 20, in which the encryption algorithm includes the operations of:
a) selecting secret key p, derived from the context, being a prime number greater then 2,
b) selecting secret key n, derived from the context, being a positive integer greater then 0,
c) selecting modulus m, being a positive integer, m=pⁿ,
d) selecting an encryption key α, derived from the context, which is a member of the finite group Mₘ of residue classes prime to m under multiplication modulo m, and being prime to θ(m), where θ(m)=pⁿ(1−1/p);
e) selecting a communication key α1, which is a member of the finite group Mₘ of residue classes prime to m under multiplication modulo m, and being prime to θ(m), where α1 can be determined using α*α1≡1modθ(m).

22. The authentication and data security system of claim 21, in which the decryption algorithm includes processing the communication key as a member of Zₘ whereby the operations can be determined using α*α1≡1modθ(m).

23. The authentication and data security system of claim 22, in which the encryption algorithm includes a unique context parameter that varies the communication key for each communication session, the key data being thereby indeterminable by an outside party subsystem who might monitor a series of such communication keys, the parameter being derived from the date and time of each such communication session and a number of the current communication session in a series of communications between the first and second parties, and the number is stored as incremental data by each of the first and second parties to enable successive authentication and communication sessions.

24. The authentication and data security system of claim 1, 11, or 17, in which the first party subsystem is within a cellular phone and the second party subsystem is within a cellular phone company's system.
